(19) United States
(12) Patent Application Publication
(10) Pub. No.: US 2007/0008459 A1
(43) Pub. Date: Jan. 11, 2007

(54) Polarizing Film, Method of Manufacturing the Same and Liquid Crystal Display Device Having the Same

(75) Inventors: Won-Sang Park, Gyeonggi-do (KR); Kee-Han Uh, Gyeonggi-do (KR); Hae-Young Yun, Gyeonggi-do (KR); Sang-Woo Kim, Gyeonggi-do (KR); Jae-Ik Kim, Gangwon-do (KR); Seung-Kyu Lee, Gyeonggi-do (KR); Sung-Eun Cha, Gyeongsangnam-do (KR); Young-Joo Chang, Gyeonggi-do (KR); Jae-Young Lee, Gyeonggi-do (KR)

Correspondence Address: PATENT LAW GROUP LLP, 2635 NORTH FIRST STREET, SUITE 223, SAN JOSE, CA, 95134, US

(73) Assignee: SAMSUNG ELECTRONICS CO., LTD., Gyeonggi-do (KR)

(21) Appl. No.: 11/422,736

(22) Filed: Jun. 7, 2006

(30) Foreign Application Priority Data
Jul. 11, 2005 (KR) 10-2005-0062016

(51) Int. Cl. G02F 1/1335

(52) U.S. Cl. 349/96; 349/114

(57) ABSTRACT

A polarizing film includes a pressure sensitive adhesive layer, a phase difference layer, a polarizing layer and a transparent protecting layer. The phase difference layer is on the pressure sensitive adhesive layer. The phase difference layer is extended in a first direction. The polarizing layer is on the phase difference layer. The polarizing layer is extended in a second direction. The transparent protecting film is on the polarizing layer. Therefore, the thickness of the polarizing film is decreased, and the yield is increased.

### CROSS-REFERENCE OF RELATED APPLICATION

The present application claims priority from Korean Patent Application No. 2005-62016, filed on Jul. 11, 2005, the disclosure of which is hereby incorporated herein by reference in its entirety.

### BACKGROUND OF THE INVENTION

1. Field of the Invention

The present invention relates to a polarizing film, a method of manufacturing the polarizing film and a liquid crystal display (LCD) device having the polarizing film. More particularly, the present invention relates to a polarizing film having decreased thickness and capable of increasing yield, a method of manufacturing the polarizing film and a liquid crystal display (LCD) device having the polarizing film.

2. Description of the Related Art

A reflective LCD device displays an image using an externally provided light. In a dark place, the amount of the externally provided light is decreased so that the reflective LCD device does not display the image.

A transmissive LCD device displays the image using an internally provided light that is generated from a backlight assembly. Although an amount of the externally provide light is decreased, the transmissive LCD device displays the image. However, a power consumption of the transmissive LCD device is increased so that size and weight of the transmissive LCD device are increased.

A reflective-transmissive LCD device has been developed to solve the above-mentioned problems. The reflective-transmissive LCD device includes a reflection mode and a transmission mode.

A polarizing film of the reflective-transmissive LCD device is about four times to about ten times more expensive than a polarizing film of the transmissive LCD device. In addition, a thickness of the polarizing film of the transmissive LCD device is about 135 μm, and a thickness of the polarizing film of the reflective-transmissive LCD device is about 260 μm that is about twice the thickness of the polarizing film of the transmissive LCD device.

Furthermore, five materials are laminated through three pressure sensitive adhesive (PSA) laminating processes to form the polarizing film of the reflective-transmissive polarizing film. Therefore, particles are easily interposed in the polarizing film of the reflective-transmissive polarizing film so that the yield of the polarizing film of the reflective-transmissive polarizing film is decreased, and the manufacturing cost of the polarizing film of the reflective-transmissive polarizing film is increased.

### SUMMARY OF THE INVENTION

The present invention provides a polarizing film having decreased thickness and capable of increasing yield.

The present invention also provides a method of manufacturing the above-mentioned polarizing film.

The present invention also provides a liquid crystal display (LCD) device having the polarizing film.

A polarizing film in accordance with one embodiment of the present invention includes a pressure sensitive adhesive layer, a phase difference layer, a polarizing layer and a transparent protecting layer. The phase difference layer is on the pressure sensitive adhesive layer. The phase difference layer is extended in a first direction. The polarizing layer is on the phase difference layer. The polarizing layer is extended in a second direction. The transparent protecting film is on the polarizing layer.

A method of manufacturing a polarizing film in accordance with one embodiment of the present invention is provided as follows. A phase difference film extended in a second direction is laminated on a lower surface of a polarizing film extended in a first direction. A transparent protecting film is laminated on an upper surface of the polarizing film. A surface treatment film is laminated on the transparent protecting film. Blocking films are laminated on the surface treatment film and the phase difference film, respectively.

An LCD device in accordance with one aspect of the present invention includes an LCD panel, a lower optical film assembly and an upper optical film assembly. The LCD panel has a liquid crystal layer. The lower optical film assembly is under the LCD panel. The lower optical film assembly includes a first phase difference layer and a first polarizing layer extended in a different direction from the first phase difference layer. The upper optical film assembly is on the LCD panel. The upper optical film assembly includes a second phase difference layer and a second polarizing layer extended in a different direction from the second phase difference layer.

An LCD device in accordance with another aspect of the present invention includes an upper substrate, a liquid crystal layer, a lower substrate, a lower optical film assembly and an upper optical film assembly. The lower substrate is combined with the upper substrate so that the liquid crystal layer is interposed between the upper and lower substrates. The lower substrate includes a switching element, a pixel electrode and a reflecting plate. The pixel electrode is electrically connected to the switching element. The reflecting plate is on the pixel electrode to define a reflection region from which an externally provided light is reflected and a transmission region through which an internally provided light passes. The lower optical film assembly includes a first pressure sensitive adhesive layer, a first phase difference layer, a first polarizing layer and a first transparent protecting film. The first pressure sensitive adhesive layer is under the lower substrate. The first phase difference layer is on the first pressure sensitive adhesive layer. The first phase difference layer is extended in a first direction. The first polarizing layer is on the first phase difference layer. The first polarizing layer is extended in a second direction. The first transparent protecting film is on the first polarizing layer. The upper optical film assembly includes a second pressure sensitive adhesive layer, a second phase difference layer, a second polarizing layer and a second transparent protecting film. The second pressure sensitive adhesive layer is on the upper substrate. The second phase difference layer is on the second pressure sensitive adhesive layer. The second phase difference layer is extended in a third direction. The second polarizing layer is on the second phase difference layer. The second polarizing layer is extended in a fourth direction. The second transparent protecting film is on the second polarizing layer.

According to the present invention, the λ/4 phase difference film having different extension direction from the polarizing layer is on an opposite side of the polarizing film to the surface treatment layer so that a thickness of the polarizing film is decreased, and a yield of the polarizing film is increased. In addition, particles may not be included in the polarized film.

### BRIEF DESCRIPTION OF THE DRAWINGS

The above and other advantages of the present invention will become more apparent by describing in detail exemplary embodiments thereof with reference to the accompanying drawings, in which:

FIG. 1 is a cross-sectional view showing a reflective-transmissive polarizing film in accordance with one embodiment of the present invention;

FIG. 2 is a cross-sectional view showing a method of manufacturing the reflective-transmissive polarizing film shown in FIG. 1;

FIG. 3 is a cross-sectional view showing a liquid crystal display (LCD) device in accordance with another embodiment of the present invention; and

FIGS. 4 and 5 are cross-sectional views showing an operation of the LCD device shown in FIG. 3.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

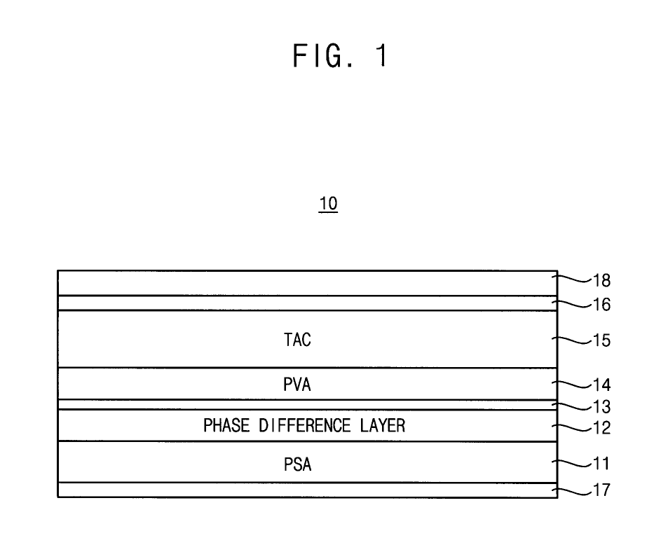

FIG. 1 is a cross-sectional view showing a reflective-transmissive polarizing film in accordance with one embodiment of the present invention.

Referring to FIG. 1, the polarizing film 10 includes a pressure sensitive adhesive (PAS) layer 11, a phase difference layer 12, an adhesive layer 13, a polarizing layer 14, a transparent protecting film 15, a surface treatment layer 16, a first blocking film 17 and a second blocking film 18. The polarizing layer 14 may be a polyvinyl alcohol (PVA) layer. The transparent protecting film 15 may be a triacetylcellulose (TAC) layer.

The pressure sensitive adhesive layer 11 includes an adhesive material, and has a film shape. An adhesiveness of the pressure sensitive adhesive layer 11 varies in response to an externally provided pressure. A refractive index of the adhesive material may be about 1.46 to about 1.52. Examples of the adhesive material that can be used for the pressure sensitive adhesive layer 11 include an acryl based adhesive material or a synthetic rubber based material. The pressure sensitive adhesive layer 11 may further include micro-particles to control the refractive index. Examples of the micro-particles that can be used to control the refractive index of the pressure sensitive adhesive layer 11 may include zirconium.

The phase difference layer 12 is extended in a first direction. The phase difference layer 12 is on the pressure sensitive adhesive layer 11. When a linearly polarized light is incident into the phase difference layer 12, a circularly polarized light exits from the phase difference layer 12. When the circularly polarized light is incident into the phase difference layer 12, a linearly polarized light exits from the phase difference layer 12.

The phase difference layer 12 includes a birefringence film, an alignment film of a liquid crystal polymer, a liquid crystal layer fixed by a film, etc. A polymer may be extended to form the birefringence film. Examples of the polymer that can be used for the birefringence film include polycarbonate, polyvinyl alcohol, polystyrene, polymethacrylate, polypropylene, polyolefin, polyarylate, polyamide, etc. The phase difference film 12 may be a λ/4 phase difference film. The phase difference layer 12 may include a uniaxial film. Alternatively, the phase difference layer 12 may include a biaxial film.

When the phase difference layer 12 includes the uniaxial film, a retardation Ro of the phase difference layer 12 is about 80 nm to about 160 nm when viewed on a plane.

When the phase difference layer 12 includes the biaxial film, a retardation Rth of the phase difference layer 12 in the thickness direction is about 80 nm to about 160 nm, and a retardation Ro of the phase difference layer when viewed on the plane is about 100 nm to about 200 nm. A refractive index ny of the biaxial film in Y-direction is different from a refractive index nz of the biaxial film in Z-direction. That is, ny≠nz, wherein nx, ny and nz represent a refractive index of the biaxial film in X-direction, the refractive index of the biaxial film in the Y-direction, and the refractive index of the biaxial film in the Z-direction, respectively. The X-direction, the Y-direction and the Z-direction represent a direction of a maximum refractive index, a direction of a minimum refractive index and a thickness direction of the biaxial film, respectively. A refractive index ny′ of the uniaxial film in Y-direction is substantially same as a refractive index nz′ of the unizxial film in Z-direction. That is, the uniaxial film satisfies ny′=nz′, wherein nx′, ny′ and nz′ represent a refractive index of the uniaxial film in X-direction, the refractive index of the uniaxial film in the Y-direction, and the refractive index of the uniaxial film in the Z-direction, respectively. Alternatively, the uniaxial film may satisfy nx′=ny′.

When the phase difference layer 12 is the biaxial film, Equations 1 and 2 represent the retardation Ro of the phase difference layer 12 when viewed on the plane and the retardation Rth of the phase difference layer 12 in the thickness direction.
Ro=(nx−ny)d Equation 1
Rth={(nx+ny)/2−nz}d Equation 2

In the above equations, nx, ny and nz represent the maximum refractive index of the biaxial film, the minimum refractive index of the biaxial film and a refractive index in the thickness direction, respectively, and d represents the thickness (nm) of the phase difference layer 12.

When the phase difference layer is the uniaxial film satisfying ny′=nz′, Equation 3 represents the retardation Ro′ of the phase difference layer. For example, the uniaxial film satisfying ny′=nz′ may be an A-plate.
Ro′=(nx′−ny′)d Equation 3

Alternatively, the phase difference layer may be the uniaxial film satisfying nx′=ny′, and the retardation Rth′ of the phase difference layer may be obtained by Equation 4. For example, the uniaxial film satisfying nx′=xy′ may be a C-plate.
Rth′={(nz′−ny′}d Equation 4

The adhesive layer 13 includes an adhesive material so that the phase difference layer 12 is attached to the polarizing layer 14. The adhesive layer 13 may be an adhesiveness improving layer. Examples of the adhesive material that can be used for the adhesive layer 13 include a polyvinyl alcohol (PVA) based material, a urethane based material, etc. A refractive index of the adhesive material may be about 1.46 to about 1.52. Examples of polyvinyl alcohols that can be used for the adhesive layer 13 include polyvinyl alcohol, partially saponified polyvinyl acetate, carboxylized polyvinyl alcohol, formylized polyvinyl alcohol, etc. The adhesive layer 13 may further include a soluble crosslinking agent. Examples of the soluble crosslinking agent that can be used for the adhesive layer 13 include boric acid, borax, glutaric aldehyde, melanin, nitric acid, etc. Examples of the urethane based material that can be used for the adhesive layer 13 include a reactive adhesive having polyol or polyisocynate, a solution having polyurethane, an emulsion having polyurethane, etc.

The polarizing layer 14 is extended in a second direction. The polarizing layer 14 is on the phase difference layer 12.

The transparent protecting film 15 is on the polarizing layer 14. For example, the transparent protecting film 15 may include an acetate based material such as triacetylcellulose (TAC). In particular, a surface of the transparent protecting film 15 may be surface treated using an alkaline material. The transparent protecting film 15 may also be on both sides of the polarizing layer 14.

The surface treatment layer 16 is on the transparent protecting film 15. The surface treatment layer 16 may include a hard coating layer, an antireflection layer, an antisticking layer, an antiglare layer, etc.

An ultraviolet curable resin such as silicone may be solidified to form the hard coating layer to protect a surface of the polarizing film 10 from an impact and a scratch.

The antisticking layer prevents the attaching of the polarizing film 10 to another elements.

The antiglare layer prevents the reflection of the externally provided light to improve a contrast ratio of a display device. The antiglare layer may be formed through a sand blast process, an embossing process, etc. Alternatively, transparent micro particles may be included in the surface treatment layer 16 to form the antiglare layer. A diameter of each of the micro particles may be about 0.5 μm to about 20 μm. Examples of the transparent micro particles that can be used for the surface treatment layer 16 include silica, alumina, titania, zirconia, tin oxide, indium oxide, cadmium oxide, ammonium oxide, etc. The transparent micro particles may be conductive inorganic particles, organic particles, etc. The organic particles may include a crosslinked polymer, a non-cross linked polymer, etc. A ratio of a transparent matrix of the to the transparent micro particles is about 100:2 to about 100:70. For example, the ratio of the transparent matrix to the transparent micro particles may be about 100:5 to about 100:50. The antiglare layer may also function as a diffusion layer that diffuses an internally provided light to increase a viewing angle of the display device.

In FIG. 1, the surface treatment layer 16 is different from the transparent protecting film 15. Alternatively, the hard coating treatment, the antisticking treatment, the antiglare treatment, etc., may be directly performed on the transparent protecting film 15 so that the surface treatment layer 16 may be omitted.

The first blocking film 17 is on the pressure sensitive adhesive layer 11, and the second blocking film 18 is on the surface treatment layer 16. The first and second blocking films 17 and 18 block the introduction of the external impurities.

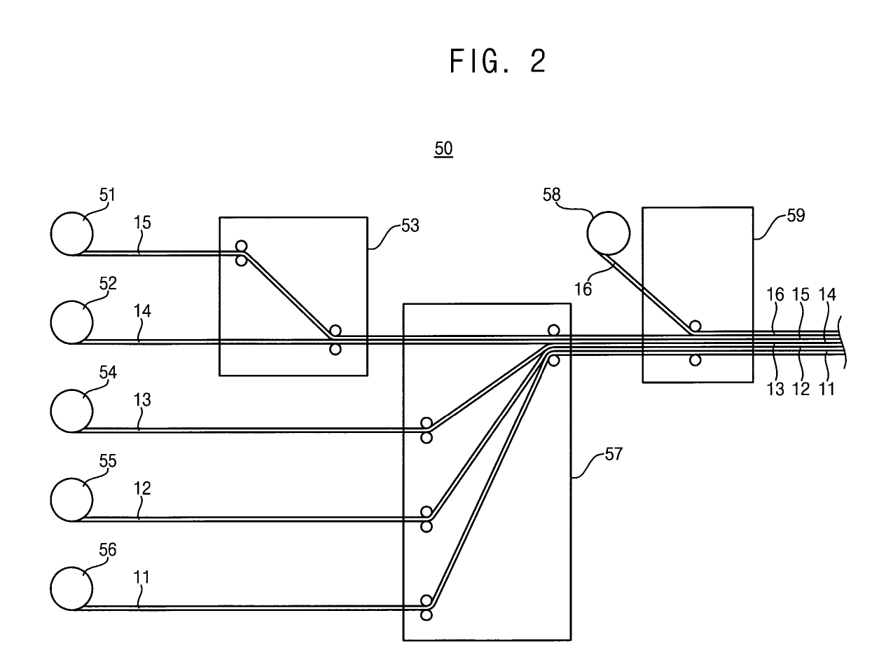

FIG. 2 is a cross-sectional view showing a method of manufacturing the reflective-transmissive polarizing film shown in FIG. 1.

Referring to FIG. 2, a device for manufacturing the reflective-transmissive polarizing film includes a transparent protecting film providing part 51, a polarizing film providing part 52, a first laminating part 53, a first adhesive film providing part 54, a phase difference film providing part 55, a second adhesive film providing part 56, a second laminating part 57, a surface treatment film providing part 58 and a third laminating part 59.

The transparent film providing part 51 provides the first laminating part 53 with the transparent protecting film 15 that is rolled on a roller. The polarizing film providing part 52 provides the first laminating part 53 with the polarizing film 14 that is rolled in a roller. The first laminating part 53 laminates the transparent protecting film 15 with the polarizing film 14, and the second laminating part 57 receives the laminated transparent protecting film 15 and the polarizing film 14.

The polarizing film 14 is extended in a first direction, and rolled on a roller.

The first adhesive film providing part 54 provides the second laminating part 57 with the first adhesive film 13 that is rolled on a roller. The phase difference film providing part 55 provides the second laminating part 57 with the phase difference film 12 that is rolled on a roller. The second adhesive film providing part 56 provides the second laminating part 57 with the second adhesive film 11 that is rolled on a roller.

The phase difference film 12 is extended in a second direction that is difference from the first direction, and rolled on a roller. The first direction of the polarizing film 14 forms an angle of about 35° to about 55° with respect to the second direction of the phase difference film 12 when viewed on a plane. The phase difference film 12 may be a λ/4 phase difference film. The phase difference layer 12 may include a uniaxial film, and a retardation Ro of the phase difference layer 12 when viewed on a plane is about 80 nm to about 160 nm. Alternatively, the phase difference layer 12 may include a biaxial film, and a retardation Rth of the phase difference layer 12 in a thickness direction and a retardation Ro of the phase difference layer when viewed on the plane may be about 80 nm to about 160 nm, and about 100 nm to about 200 nm.

The second adhesive film 11 may be a pressure sensitive adhesive layer (PSA). An adhesiveness of the PAS layer 11 varies in response to the externally provided pressure.

The second laminating part 57 laminates the laminated transparent protecting film 15 and the polarizing film 14 with the first adhesive film 13, the phase difference film 12 and the second adhesive film 11, and provides the third laminating part 59 with the laminated transparent protecting film 15, the polarizing film 14, the first adhesive film 13, the phase difference film 12 and the second adhesive film 11.

The surface treatment film providing part 59 provides the third laminating part 59 with the surface treatment film 16 that is rolled on a roller.

The third laminating part 59 laminates the surface treatment film 16 with the transparent protecting film 15 that is from the second laminating part 57 to complete the polarizing film 10 (shown in FIG. 1).

Alternatively, a first blocking film providing part (not shown) may be under the pressure sensitive adhesive layer 11 to provide the polarizing film 10 (shown in FIG. 1) with the first blocking film 17. In addition, a second blocking film providing part (not shown) may be on the surface treatment layer 16 to provide the polarizing film 10 (shown in FIG. 1) with the second blocking film 18.

In FIGS. 1 and 2, the device 50 for manufacturing the polarizing film 10 includes the first, second and third laminating parts 53, 57 and 59. Alternatively, the device 50 for manufacturing the polarizing film 10 may include only two laminating parts or no less than four laminating parts.

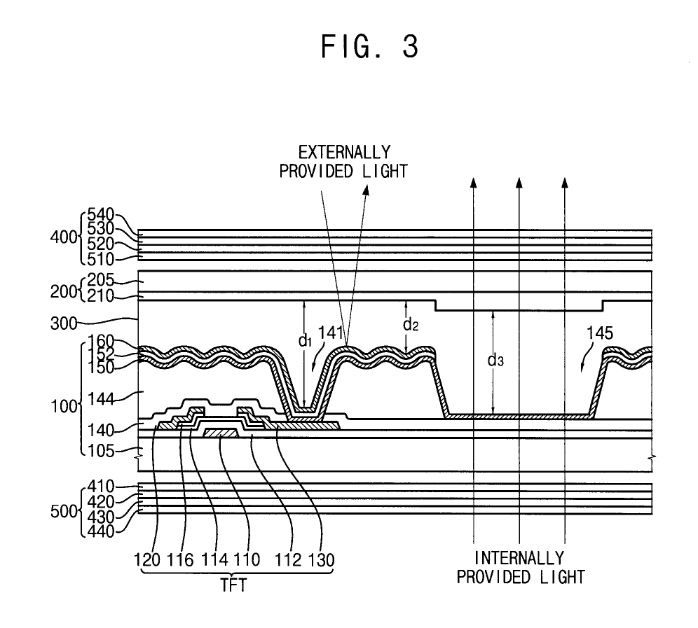

FIG. 3 is a cross-sectional view showing a liquid crystal display (LCD) device in accordance with another embodiment of the present invention.

Referring to FIG. 3, the LCD device includes an array substrate 100, a color filter substrate 200, a liquid crystal layer 300, a lower optical film assembly 500 and an upper optical film assembly 400. The liquid crystal layer 300 is interposed between the array substrate 100 and the color filter substrate 200. The lower optical film assembly 500 is under the array substrate 100. The upper optical film assembly 400 is on the color filter substrate 200.

The array substrate 100 includes a first transparent substrate 105, a switching element TFT and an organic insulating layer 144. The switching element TFT is on the first transparent substrate 105, and includes a gate electrode 110, a semiconductor layer 114, an ohmic contact layer 116, a source electrode 120 and a drain electrode 130. The organic insulating layer 144 covers the switching element TFT, and partially exposes the drain electrode 130 through a first contact hole 141. A plurality of grooves and protrusions may be formed on the organic insulating layer 144 to increase a light reflectivity of the array substrate 100.

The array substrate 100 may further include a pixel electrode 150, an insulating interlayer 152 and a reflecting plate 160. The pixel electrode 150 is on the organic insulating layer 144, and is electrically connected to the drain electrode 130 through the first contact hole 141. The insulating interlayer 152 covers the switching element TFT. The reflecting plate 160 is on the insulating interlayer 152 to define a reflection region and a transmission window 145. The reflecting plate 160 corresponds to the reflection region.

The pixel electrode 150 includes a transparent conductive material. Examples of the transparent conductive material that can be used for the pixel electrode 150 include indium tin oxide (ITO), indium zinc oxide (IZO), tin oxide (TO), etc. A storage capacitor line (not shown) that is spaced apart from the switching element TFT may be formed on the first transparent substrate 105 so that the storage capacitor line (not shown), the pixel electrode 150 and the organic insulating layer 114 may define a storage capacitor.

The reflecting plate 160 is on the insulating interlayer 152 corresponding to the reflection region. In FIG. 3, the reflecting plate 160 is spaced apart from the pixel electrode 150 by the insulating interlayer 152. Alternatively, the reflection plate 160 may make contact with the pixel electrode so that the reflecting plate 160 may be electrically connected to the pixel electrode 150.

The color filter substrate 200 includes a second transparent substrate 205, a black matrix layer (not shown), a color filter layer 210 and a surface protecting layer (not shown). The black matrix layer (not shown) is on the second transparent substrate 205 to define red, green and blue pixel regions. The color filter layer 210 is on the red, green and blue pixel regions that are defined by the black matrix layer (not shown). The surface protecting layer (not shown) is on the black matrix (not shown) and the color filter layer 210 to protect the black matrix layer (not shown) and the color filter layer 210. Alternatively, the color filter layer 210 may be partially overlapped to form the black matrix (not shown). The color filter substrate 200 may further include a common electrode layer (not shown) corresponding to the pixel electrode 150.

The liquid crystal layer 300 is interposed between the array substrate 100 and the color filter substrate 200. The externally provided light that passes through the color filter substrate 200 and the internally provided light that passes through the transmission window 145 pass through the light crystal layer 300 to display an image. In particular, liquid crystals of the liquid crystal layer 300 varies arrangement in response to an electric field formed between the pixel electrode 150 and the common electrode (not shown), and thus a light transmittance of the liquid crystal layer 300 is changed, thereby displaying the image.

The liquid crystal layer 300 is divided into a first portion corresponding to the first contact hole 141, a second portion corresponding to a remaining portion of the reflection region, and a third portion corresponding to the transmission window 145. The first, second and third portions of the liquid crystal layer 300 have different thicknesses from each other. A first cell gap d1 of the first portion of the liquid crystal layer 300 is greater than a second cell gap d2 of the second portion of the liquid crystal layer 300, and a third cell gap d3 of the third portion of the liquid crystal layer 300 is no smaller than the first cell gap d1 of the first portion of the liquid crystal layer 300. That is, d2<d1≦d3.

The organic insulating layer 144 may not be formed on the first contact hole 141. A portion of the organic insulating layer 144 corresponding to the second portion of the liquid crystal layer 300 has a greater thickness than a portion of the organic insulating layer 144 corresponding to the first contact hole 141 that corresponds to the first portion of the liquid crystal layer 300. A portion of the organic insulating layer 144 corresponding to the transmission window 145 that corresponds to the third portion of the liquid crystal layer 300 has no greater thickness than the portion of the organic insulating layer 144 corresponding to the first contact hole 141. Therefore, optical characteristics of the first, second and third portions of the liquid crystal layer 300 are Δnd1, Δnd2 and Δnd3, respectively, wherein Δn and ‘d’ represent anisotropy of a refractive index and cell gap of the liquid crystal layer 300, respectively.

The first, second and third cell gaps d1, d2 and d3 vary thicknesses in response to the liquid crystal layer 300, the upper optical film assembly 400, the lower optical film assembly 500, etc. For example, the second cell gap d2 may be smaller than about 1.7 μm, and the third cell gap d3 may be smaller than about 3.3 μm.

The liquid crystal layer 300 may have a homogeneous alignment mode that has a twist angle of about 0°.

When a lower alignment layer (not shown) of the array substrate 100 is rubbed in a right direction of the LCD device, and an upper alignment layer (not shown) of the color filter substrate 200 is rubbed in a left direction of the LCD device, the twist angle of the liquid crystal layer 300 is about 0°. The left direction of the LCD device is substantially opposite to the right direction of the LCD device. Alternatively, the lower alignment layer (not shown) of the array substrate 100 may be rubbed in the left direction of the LCD device, and the upper alignment layer (not shown) of the color filter substrate 200 may be rubbed in the right direction of the LCD device.

In FIG. 3, the array substrate 100 and the color filter substrate 200 include the pixel electrode 150 and the common electrode layer (not shown), respectively. Alternatively, the LCD device may have an in-plane switching (IPS) mode, a fringe field switching (FFS) mode, a co-planar electrode (CE) mode, etc.

The lower optical film assembly 500 includes a first pressure sensitive adhesive (PSA) layer 410 that is adjacent to the array substrate 100, a first λ/4 phase difference film 420 on the first pressure sensitive adhesive layer 410, a first polarizing layer 430 of the first λ/4 phase difference film 420 and a first transparent protecting film 440 on the first polarizing layer 430. An extension direction of the first λ/4 phase difference film 420 forms an angle of about 35° to about 55° with respect to an extension direction of the first polarizing layer 430 when viewed on a plane.

The upper optical film assembly 400 includes a second pressure sensitive adhesive (PSA) layer 510 that is adjacent to the color filter substrate 200, a second λ/4 phase difference film 520 on the second pressure sensitive adhesive layer 510, a second polarizing layer 530 of the second λ/4 phase difference film 520 and a second transparent protecting film 540 on the second polarizing layer 530. An extension direction of the second λ/4 phase difference film 520 forms an angle of about 35° to about 55° with respect to an extension direction of the second polarizing layer 530 when viewed on the plane.

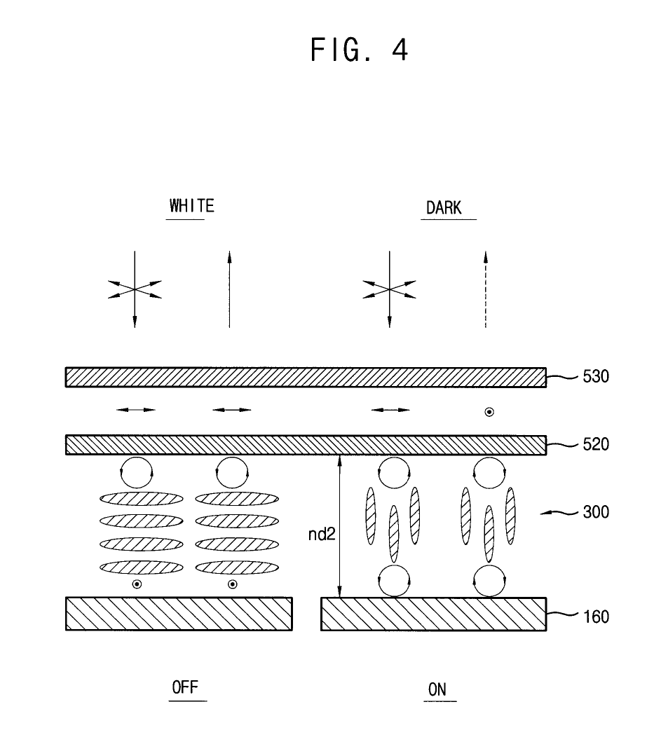

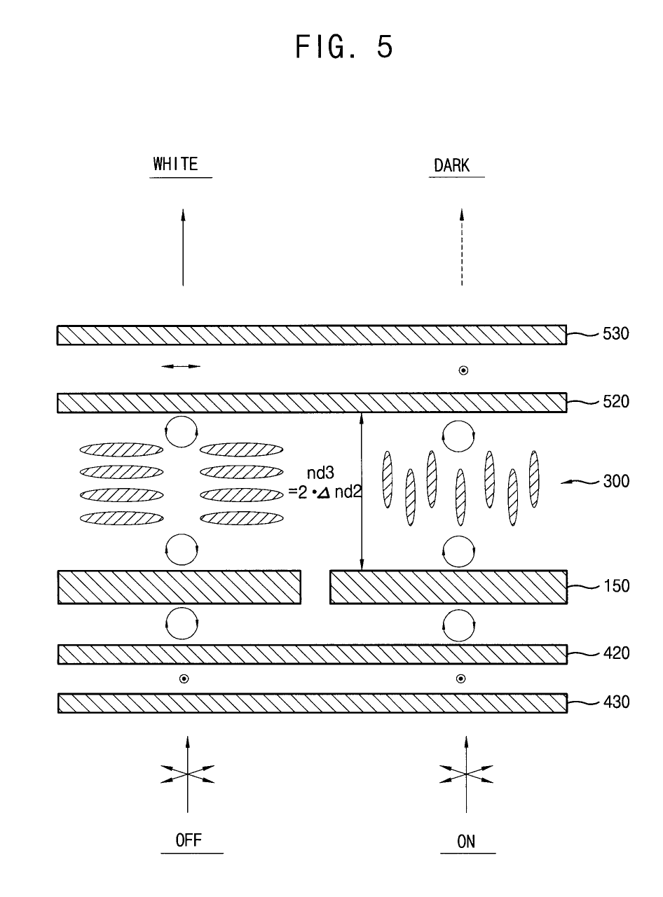

FIGS. 4 and 5 are cross-sectional views showing an operation of the LCD device shown in FIG. 3. In FIGS. 4 and 5, the LCD device has a normally white mode. In the normally white mode, the LCD device displays a white color when an electric field is not applied to the liquid crystal layer 300.

Operation of Reflection Mode

Referring to FIGS. 3 and 4, in the reflection mode, when the electric field is not applied to the liquid crystal layer 300, the externally provided light that has passed through the second polarizing layer 530 is changed into an original linearly polarized light. When the original lineally polarized light that exits from the second polarizing layer 530 has passed through the second λ/4 phase difference film 520, the original linearly polarized light is changed into a left circularly polarized light. Alternatively, a right circularly polarized light may exit from the second λ/4 phase difference film 520.

When the electric field is not applied to the liquid crystal layer 300, the liquid crystals of the liquid crystal layer 300 are aligned in a horizontal direction. When the left circularly polarized light has passed through the liquid crystal layer 300, a phase of the left polarized light is delayed by a λ/4 phase so that the left polarized light is changed into a linearly polarized light. The linearly polarized light that is from the liquid crystal layer 300 is reflected from the reflecting plate 160 to be incident into the liquid crystal layer 300 again. When the linearly polarized light has passed through the liquid crystal layer 300, a phase of the linearly polarized light is delayed by the λ/4 phase so that the linearly polarized light is changed into a left circularly polarized light. The liquid crystal layer 300 corresponding to the reflection mode has optical characteristics of the Δnd2 as shown in FIG. 3.

When the left polarized light has passed through the second λ/4 phase difference film 520, a linearly polarized light that has a substantially same polarizing direction as the original linearly polarized light exits from the second λ/4 phase difference film 520. The linearly polarized light that is from the second λ/4 phase difference film 520 passes through the second polarizing layer 530 to display the white color.

In the reflection mode, when the electric field is applied to the liquid crystal layer 300, the externally provided light that has passed through the second polarizing layer 530 is changed into the original linearly polarized light. When the original lineally polarized light that exits from the second polarizing layer 530 has passed through the second λ/4 phase difference film 520, the original linearly polarized light is changed into the left circularly polarized light.

When the electric field is applied to the liquid crystal layer 300, the liquid crystals of the liquid crystal layer 300 are aligned in a vertical direction. The left circularly polarized light passes through the liquid crystal layer 300 so that the left polarized light exits from the liquid crystal layer 300. The left circularly polarized light that is from the liquid crystal layer 300 is reflected from the reflecting plate 160 so that a right circularly polarized light exits from the reflecting plate 160. When the right circularly polarized light passes through the liquid crystal layer 300 so that the right circularly polarized light exits from the liquid crystal layer 300. When the right polarized light has passed through the second λ/4 phase difference film 520, a linearly polarized light that has a substantially perpendicular polarizing direction to the original linearly polarized light exits from the second λ/4 phase difference film 520. The linearly polarized light that is from the second λ/4 phase difference film 520 is blocked by the second polarizing layer 530 to display a block color.

Operation of Transmission Mode

Referring to FIGS. 3 and 5, in the transmission mode, when the electric field is not applied to the liquid crystal layer 300, the externally provided light that has passed through the first polarizing layer 430 is changed into an original linearly polarized light. When the original lineally polarized light that exits from the first polarizing layer 430 has passed through the first λ/4 phase difference film 420, the original linearly polarized light is changed into a right circularly polarized light. The right circularly polarized light passes through the pixel electrode 150, and is irradiated onto the liquid crystal layer 300. The liquid crystal layer 300 corresponding to the transmission mode has optical characteristics of the Δnd3 as shown in FIG. 3. The optical characteristics Δnd3 of the transmission mode is about two times of the optical characteristics Δnd2 of the reflection mode.

When the electric field is not applied to the liquid crystal layer 300, the liquid crystals of the liquid crystal layer 300 are aligned in the horizontal direction. When the right circularly polarized light has passed through the liquid crystal layer 300, a phase of the right polarized light is delayed by the λ/4 phase so that the right polarized light is changed into a linearly polarized light that has a substantially perpendicular polarizing direction to the original linearly polarized light. The linearly polarized light that is from the liquid crystal layer 300 passes through the second polarizing layer 530 to display the white color.

In the transmission mode, when the electric field is applied to the liquid crystal layer 300, the externally provided light that has passed through the first polarizing layer 430 is changed into the original linearly polarized light. When the original lineally polarized light that exits from the first polarizing layer 430 has passed through the first λ/4 phase difference film 420, the original linearly polarized light is changed into the right circularly polarized light. The right circularly polarized light passes through the pixel electrode 150, and is irradiated into the liquid crystal layer 300.

When the electric field is applied to the liquid crystal layer 300, the liquid crystals of the liquid crystal layer 300 are aligned in the vertical direction. The right circularly polarized light passes through the liquid crystal layer 300 so that the right circularly polarized light exits from the liquid crystal layer 300. The right circularly polarized light is incident into the second λ/4 phase difference film 520.

When the right polarized light has passed through the second λ/4 phase difference film 520, a linearly polarized light that has a substantially parallel polarizing direction to the original linearly polarized light exits from the second λ/4 phase difference film 520. The linearly polarized light that is from the second λ/4 phase difference film 520 is blocked by the second polarizing layer 530 to display a block color.

According to the present invention, the pressure sensitive adhesive layer, the phase difference layer extended in the first direction, the polarizing layer extended in the second direction and the transparent protecting film are sequentially stacked to form the reflective-transmissive polarizing film. Therefore, the λ/4 phase difference film having a different extension direction from the polarizing layer is integrally formed with the reflective-transmissive polarizing film so that a thickness of the reflective-transmissive polarizing film is decreased, and a yield of the reflective-transmissive polarizing film is increased. In addition, particles may not be interposed in the reflective-transmissive polarizing film.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A polarizing film comprising:
a phase difference layer extended in a first direction;
a polarizing layer on the phase difference layer, the polarizing layer being extended in a second direction; and
a transparent protecting film on the polarizing layer.

2. The polarizing film of claim 1, wherein the second direction forms an angle of about 35° to about 55° with respect to the first direction.

3. The polarizing film of claim 1, wherein a thickness of the phase difference layer is about 40 μm.

4. The polarizing film of claim 1, wherein a thickness of the polarizing layer is about 20 μm.

5. The polarizing film of claim 1, wherein a thickness of the transparent protecting film is about 40 μm.

6. The polarizing film of claim 1, wherein the phase difference layer comprises a λ/4 phase difference film.

7. The polarizing film of claim 1, wherein the phase difference layer comprises a uniaxial film having a retardation Ro of about 80 nm to about 160 nm when viewed on a plane.

8. The polarizing film of claim 1, wherein the phase difference layer comprises a biaxial film having a retardation Ro of about 100 nm to about 200 nm when viewed on a plane and a retardation Rth of about 80 nm to about 160 nm in a thickness direction.

9. The polarizing film of claim 1, further comprising a pressure sensitive adhesive layer on the phase difference layer opposite to the polarizing layer.

10. The polarizing film of claim 9, further comprising an adhesiveness improving layer between the phase difference layer and the polarizing layer.

11. The polarizing film of claim 10, wherein the adhesiveness improving layer comprises an auxiliary pressure sensitive adhesive layer.

12. The polarizing film of claim 10, wherein the adhesiveness improving layer comprises an adhesive material.

13. The polarizing film of claim 9, wherein a thickness of the pressure sensitive adhesive layer is about 40 μm.

14. The polarizing film of claim 9, further comprising a surface treatment layer on the transparent protecting film.

15. The polarizing film of claim 14, further comprising:
a first blocking film under the pressure sensitive adhesive layer; and
a second blocking film on the surface treatment layer.

16. The polarizing film of claim 14, wherein the surface treatment layer comprises an antireflection layer.

17. The polarizing film of claim 14, wherein the surface treatment layer comprises an antiglare layer.

18. A method of manufacturing a polarizing film comprising:
laminating a phase difference film extended in a second direction on a lower surface of a polarizing film extended in a first direction;
laminating a transparent protecting film on an upper surface of the polarizing film;
laminating a surface treatment film on the transparent protecting film; and
laminating blocking films both on the surface treatment film and the phase difference film.

19. The method of claim 18, wherein the second direction forms an angle of about 35° and about 55° with respect to the first direction.

20. The method of claim 18, wherein the phase difference film is simultaneously laminated with the transparent protecting film.

21. A liquid crystal display device comprising:
a liquid crystal display panel having a liquid crystal layer;
a lower optical film assembly under the liquid crystal display panel, the lower optical film assembly including a first phase difference layer and a first polarizing layer extended in a different direction from the first phase difference layer; and
an upper optical film assembly on the liquid crystal display panel, the upper optical film assembly including a second phase difference layer and a second polarizing layer extended in a different direction from the second phase difference layer.

22. The liquid crystal display device of claim 21, wherein the lower optical film assembly further comprises a first pressure sensitive adhesive layer under the liquid crystal display panel, and the first phase difference layer extended in a first direction and the first polarizing layer extended in a second direction are on the first pressure sensitive adhesive layer, in sequence.

23. The liquid crystal display device of claim 22, wherein the lower optical film assembly further comprises a first transparent protecting film on the first polarizing layer.

24. The liquid crystal display device of claim 21, wherein the upper optical film assembly further comprises a second pressure sensitive adhesive layer on the liquid crystal display panel, and the second phase difference layer being extended in a third direction and the second polarizing layer being extended in a fourth direction are on the second pressure sensitive adhesive layer, in sequence.

25. The liquid crystal display device of claim 24, wherein the upper optical film assembly further comprises a second transparent protecting film on the second polarizing layer.

26. A liquid crystal display device comprising:
an upper substrate;
a liquid crystal layer;
a lower substrate combined with the upper substrate so that the liquid crystal layer is interposed between the upper and lower substrates, the lower substrate including:
a switching element;
a pixel electrode electrically connected to the switching element; and
a reflecting plate on the pixel electrode to define a reflection region from which an externally provided light is reflected and a transmission region through which an internally provided light passes;
a lower optical film assembly including:
a first pressure sensitive adhesive layer under the lower substrate;
a first phase difference layer on the first pressure sensitive adhesive layer, the first phase difference layer extended in a first direction;
a first polarizing layer on the first phase difference layer, the first polarizing layer extended in a second direction; and
a first transparent protecting film on the first polarizing layer; and
an upper optical film assembly including:
a second pressure sensitive adhesive layer on the upper substrate;
a second phase difference layer on the second pressure sensitive adhesive layer, the second phase difference layer extended in a third direction;
a second polarizing layer on the second phase difference layer, the second polarizing layer extended in a fourth direction; and
a second transparent protecting film on the second polarizing layer.
